(19) United States
(12) Patent Application Publication
(10) Pub. No.: US 2010/0208179 A1
(43) Pub. Date: Aug. 19, 2010

(54) Pixel Black Mask Design and Formation Technique

(75) Inventors: Shih Chang Chang, Cupertino, CA (US); Ming Xu, Cupertino, CA (US); Mingxia Gu, Santa Clara, CA (US); Shawn Robert Gettemy, San Jose, CA (US); John Z. Zhong, Cupertino, CA (US); Cheng Chen, Cupertino, CA (US)

Correspondence Address: APPLE INC.;c/o Fletcher Yoder, PC, P.O. Box 692289, Houston, TX, 77269-2289, US

(73) Assignee: Apple Inc., Cupertino, CA (US)

(21) Appl. No.: 12/371,452

(22) Filed: Feb. 13, 2009

(51) Int. Cl. G02F 1/1335; G02F 1/1333

(52) U.S. Cl. 349/110; 349/187

(57) ABSTRACT

A display panel is provided having a first substrate including an electrode configured to generate an electric field and a second substrate including a black mask. The black mask includes an aperture configured to enable light to be transmitted through the aperture, wherein the aperture is at least substantially rectangular and includes corners that are not substantially chamfered. The display panel also includes liquid crystal disposed between the first and second substrates and configured to facilitate passage of light through the display panel in response to the electric field.

### BACKGROUND

1. Field of the Invention

Embodiments of the present disclosure relate generally to displays, such as liquid crystal displays (LCDs). More specifically, the present disclosure relates to an improved design and technique for forming a black mask in an LCD display panel.

2. Description of the Related Art

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Liquid crystal displays (LCDs) are commonly used as screens or displays for a wide variety of electronic devices, including such consumer electronics as televisions, computers, and handheld devices (e.g., cellular telephones, audio and video players, gaming systems, and so forth). Such LCD devices typically provide a flat display in a relatively thin package that is suitable for use in a variety of electronic goods. In addition, such LCD devices typically use less power than comparable display technologies, making them suitable for use in battery powered devices or in other contexts where it is desirable to minimize power usage.

The performance of an LCD may be measured with respect to a variety of factors. For example, the brightness of the display, the visibility of the display when viewed at an angle, the refresh rate of the display, and various other factors may all describe an LCD display and/or determine whether a display will be useful in the context of a given device. For example, with respect to brightness, factors which may affect the brightness of a display include the available area available to transmit light at each picture element (i.e., pixel) of the display.

The area available to transmit light may depend on the structures within the pixel. The pixels may include electrodes, glass substrates, a black mask and liquid crystal between the glass substrates. The electrodes may generate an electric field, which, in conjunction with the liquid crystal, may transmit light. The black mask, located adjacent to the liquid crystal, includes a light-absorbing frame area with an aperture to enable the transmission of light. The aperture may be formed by a removal process, such as etching, which may leave deposits of the black mask material around the edges of the aperture during the removal process. The edge deposits of black mask may block light transmission from the pixel, thereby reducing the brightness of the LCD display.

### SUMMARY

Certain aspects commensurate in scope with the originally claimed invention are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

The present disclosure relates to increasing the light transmission of LCD pixels. In accordance with the present disclosure, an LCD pixel is formed on a substrate material. A black mask is formed on the substrate for each pixel and an aperture in the black mask enables transmission of light from the pixel. The aperture in the black mask may be formed by etching using a patterning layer, such as a photoresist layer, disposed on the black mask. In certain embodiments, the patterning layer has a substantially rectangular aperture with overshaped corners. Use of such a substantially rectangular aperture and overshaped corners in the patterning layer enables an increased portion of the black mask to be exposed for etching, thereby increasing the area of the aperture in the black mask, and reducing the likelihood of chamfered corners in the black mask. That is, an increased area in the patterning layer, including overshaped corners in the shape of ellipses or circles, for example, enables a larger portion of the black mask to be removed by etching. The increased portion of black mask removed in turn increases the amount of light that can be transmitted by the pixel.

### BRIEF DESCRIPTION OF THE DRAWINGS

Advantages of the invention may become apparent upon reading the following detailed description and upon reference to the drawings in which:

FIG. 1 is a block diagram of exemplary components of an electronic device, in accordance with aspects of the present disclosure;

FIG. 2 is a front view of a handheld electronic device in accordance with aspects of the present disclosure;

FIG. 3 is a view of a computer in accordance with aspects of the present disclosure;

FIG. 4 is an exploded view of exemplary layers of a pixel of an LCD panel, in accordance with aspects of the present disclosure;

FIG. 5 is a circuit diagram of switching and display circuitry of LCD pixels, in accordance with aspects of the present disclosure;

FIG. 6 is a sectional side view of layers of a pixel during assembly, including a black mask layer and an upper substrate, in accordance with aspects of the present disclosure;

FIG. 7 is a sectional side view of layers of a pixel during assembly, including the black mask layer, upper substrate and a resist layer, in accordance with aspects of the present disclosure;

FIG. 8 is a sectional side view of layers of a pixel during assembly, including the black mask layer and upper substrate, in accordance with aspects of the present disclosure;

FIG. 9 is a top view of layers of a pixel during assembly, including a black mask layer and a resist layer, in accordance with aspects of the present disclosure;

FIG. 10 is a top view of layers of another pixel during assembly, including a black mask layer and a resist layer, in accordance with aspects of the present disclosure;

FIG. 11 is a top view of layers of a pixel during assembly, including a black mask layer and an upper substrate, in accordance with aspects of the present disclosure;

FIG. 12 is a top view of layers of a pixel during assembly, including a black mask layer and an upper substrate, in accordance with aspects of the present disclosure; and

FIG. 13 is a flow chart illustrating a process for forming a black mask layer of a display panel.

### DETAILED DESCRIPTION OF SPECIFIC EMBODIMENTS

One or more specific embodiments of the present invention will be described below. These described embodiments are only exemplary of the present invention. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The application is generally directed to increasing light transmittance in LCD pixels. In certain embodiments, the increase in light transmittance may be accomplished forming a black mask layer configured to expose a greater portion of the light-emitting liquid crystal. This increase in the aperture of the black mask may be accomplished by a process including etching a portion of the black mask based on a pattern in a patterning layer, such as a photoresist layer. The pattern in the photoresist may include a substantially rectangular aperture with overshaped corners. Thus, the pattern of the photoresist enables a larger portion of the black mask to be removed, such that the corners of the black mask intersect at substantially right angles, thereby increasing the aperture for light transmission.

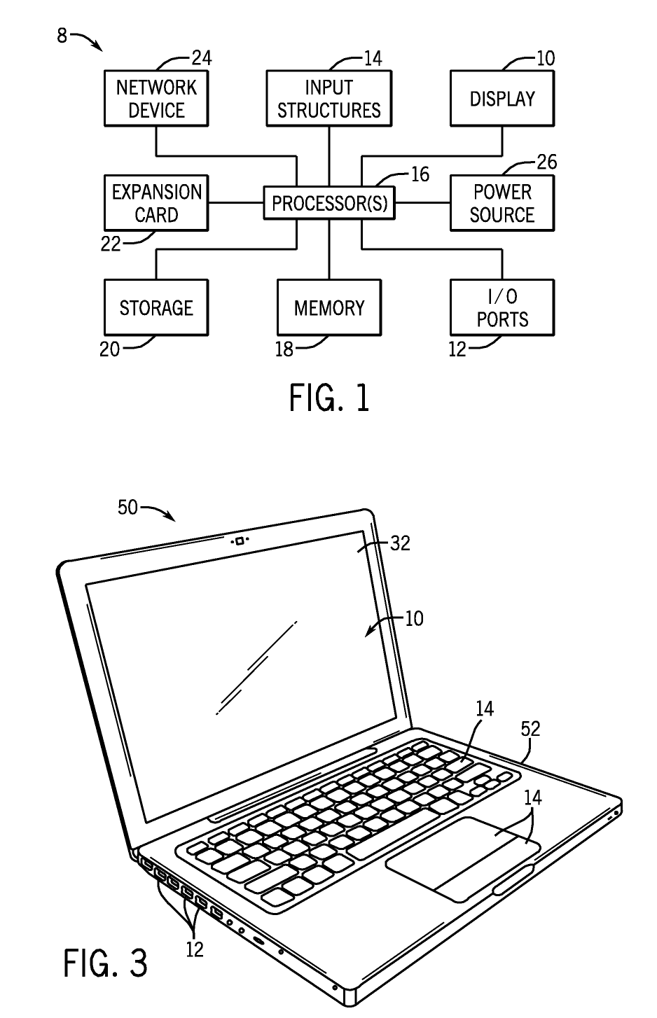

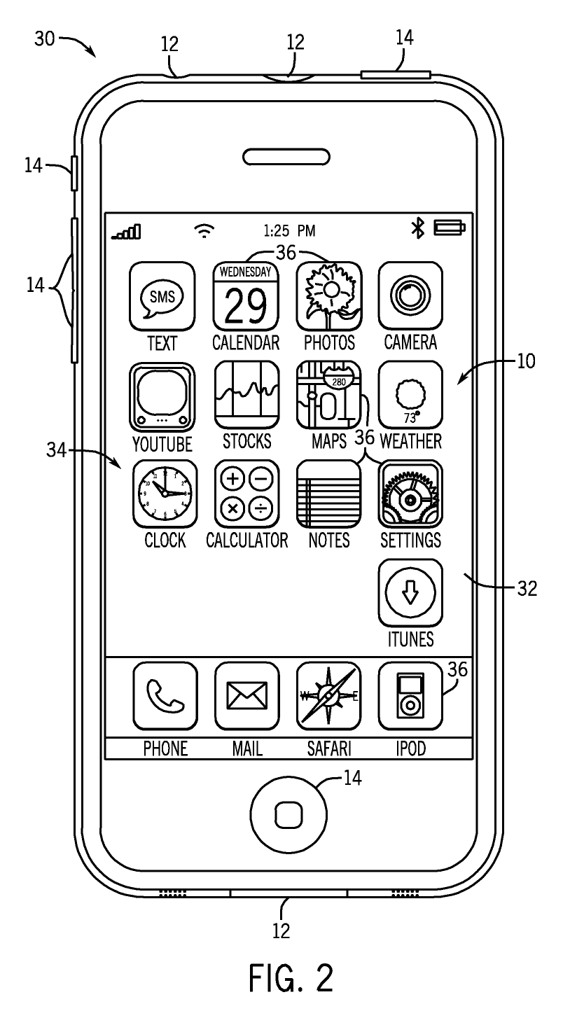

With these foregoing features in mind, a general description of suitable electronic devices using LCD displays having such increased light transmittance is provided below. In FIG. 1, a block diagram depicting various components that may be present in electronic devices suitable for use with the present techniques is provided. In FIG. 2, one example of a suitable electronic device, here provided as a handheld electronic device, is depicted. In FIG. 3, another example of a suitable electronic device, here provided as a computer system, is depicted. These types of electronic devices, and other electronic devices providing comparable display capabilities, may be used in conjunction with the present techniques.

An example of a suitable electronic device may include various internal and/or external components which contribute to the function of the device. FIG. 1 is a block diagram illustrating the components that may be present in such an electronic device 8 and which may allow the device 8 to function in accordance with the techniques discussed herein. Those of ordinary skill in the art will appreciate that the various functional blocks shown in FIG. 1 may comprise hardware elements (including circuitry), software elements (including computer code stored on a computer-readable medium) or a combination of both hardware and software elements. It should further be noted that FIG. 1 is merely one example of a particular implementation and is merely intended to illustrate the types of components that may be present in a device 8. For example, in the presently illustrated embodiment, these components may include a display 10, I/O ports 12, input structures 14, one or more processors 16, a memory device 18, a non-volatile storage 20, expansion card(s) 22, a networking device 24, and a power source 26.

With regard to each of these components, the display 10 may be used to display various images generated by the device 8. In one embodiment, the display 10 may be a liquid crystal display (LCD). For example, the display 10 may be an LCD employing fringe field switching (FFS), in-plane switching (IPS), or other techniques useful in operating such LCD devices. Additionally, in certain embodiments of the electronic device 8, the display 10 may be provided in conjunction with touch-sensitive element, such as a touch screen, that may be used as part of the control interface for the device 8.

The I/O ports 12 may include ports configured to connect to a variety of external devices, such as a power source, headset or headphones, or other electronic devices (such as handheld devices and/or computers, printers, projectors, external displays, modems, docking stations, and so forth). The I/O ports 12 may support any interface type, such as a universal serial bus (USB) port, a video port, a serial connection port, an IEEE-1394 port, an Ethernet or modem port, and/or an AC/DC power connection port.

The input structures 14 may include the various devices, circuitry, and pathways by which user input or feedback is provided to the processor 16. Such input structures 14 may be configured to control a function of the device 8, applications running on the device 8, and/or any interfaces or devices connected to or used by the electronic device 8. For example, the input structures 14 may allow a user to navigate a displayed user interface or application interface. Examples of the input structures 14 may include buttons, sliders, switches, control pads, keys, knobs, scroll wheels, keyboards, mice, touchpads, and so forth.

In certain embodiments, an input structure 14 and display 10 may be provided together, such an in the case of a touchscreen where a touch sensitive mechanism is provided in conjunction with the display 10. In such embodiments, the user may select or interact with displayed interface elements via the touch sensitive mechanism. In this way, the displayed interface may provide interactive functionality, allowing a user to navigate the displayed interface by touching the display 10.

User interaction with the input structures 14, such as to interact with a user or application interface displayed on the display 10, may generate electrical signals indicative of the user input. These input signals may be routed via suitable pathways, such as an input hub or bus, to the processor(s) 16 for further processing.

The processor(s) 16 may provide the processing capability to execute the operating system, programs, user and application interfaces, and any other functions of the electronic device 8. The processor(s) 16 may include one or more microprocessors, such as one or more “general-purpose” microprocessors, one or more special-purpose microprocessors and/or ASICS, or some combination of such processing components. For example, the processor 16 may include one or more reduced instruction set (RISC) processors, as well as graphics processors, video processors, audio processors and/or related chip sets.

The instructions or data to be processed by the processor(s) 16 may be stored in a computer-readable medium, such as a memory 18. Such a memory 18 may be provided as a volatile memory, such as random access memory (RAM), and/or as a non-volatile memory, such as read-only memory (ROM). The memory 18 may store a variety of information and may be used for various purposes. For example, the memory 18 may store firmware for the electronic device 8 (such as a basic input/output instruction or operating system instructions), various programs, applications, or routines executed on the electronic device 8, user interface functions, processor functions, and so forth. In addition, the memory 18 may be used for buffering or caching during operation of the electronic device 8.

The components may further include other forms of computer-readable media, such as a non-volatile storage 20, for persistent storage of data and/or instructions. The non-volatile storage 20 may include flash memory, a hard drive, or any other optical, magnetic, and/or solid-state storage media. The non-volatile storage 20 may be used to store firmware, data files, software, wireless connection information, and any other suitable data.

The embodiment illustrated in FIG. 1 may also include one or more card or expansion slots. The card slots may be configured to receive an expansion card 22 that may be used to add functionality, such as additional memory, I/O functionality, or networking capability, to the electronic device 8. Such an expansion card 22 may connect to the device through any type of suitable connector, and may be accessed internally or external to the housing of the electronic device 8. For example, in one embodiment, the expansion card 22 may be flash memory card, such as a SecureDigital (SD) card, mini- or microSD, CompactFlash card, Multimedia card (MMC), or the like.

The components depicted in FIG. 1 also include a network device 24, such as a network controller or a network interface card (NIC). In one embodiment, the network device 24 may be a wireless NIC providing wireless connectivity over any 802.11 standard or any other suitable wireless networking standard. The network device 24 may allow the electronic device 8 to communicate over a network, such as a Local Area Network (LAN), Wide Area Network (WAN), or the Internet. Further, the electronic device 8 may connect to and send or receive data with any device on the network, such as portable electronic devices, personal computers, printers, and so forth. Alternatively, in some embodiments, the electronic device 8 may not include a network device 24. In such an embodiment, a NIC may be added as an expansion card 22 to provide similar networking capability as described above.

Further, the components may also include a power source 26. In one embodiment, the power source 26 may be one or more batteries, such as a lithium-ion polymer battery or other type of suitable battery. The battery may be user-removable or may be secured within the housing of the electronic device 8, and may be rechargeable. Additionally, the power source 26 may include AC power, such as provided by an electrical outlet, and the electronic device 8 may be connected to the power source 26 via a power adapter. This power adapter may also be used to recharge one or more batteries if present.

With the foregoing in mind, FIG. 2 illustrates an electronic device 8 in the form of a handheld device 30, here a cellular telephone. It should be noted that while the depicted handheld device 30 is provided in the context of a cellular telephone, other types of handheld devices (such as media players for playing music and/or video, personal data organizers, handheld game platforms, and/or combinations of such devices) may also be suitably provided as the electronic device 8. Further, a suitable handheld device 30 may incorporate the functionality of one or more types of devices, such as a media player, a cellular phone, a gaming platform, a personal data organizer, and so forth.

For example, in the depicted embodiment, the handheld device 30 is in the form of a cellular telephone that may provide various additional functionalities (such as the ability to take pictures, record audio and/or video, listen to music, play games, and so forth). As discussed with respect to the general electronic device of FIG. 1, the handheld device 30 may allow a user to connect to and communicate through the Internet or through other networks, such as local or wide area networks. The handheld electronic device 30, may also communicate with other devices using short-range connections, such as Bluetooth and near field communication. By way of example, the handheld device 30 may be a model of an iPod® or iPhone® available from Apple Inc. of Cupertino, Calif.

In the depicted embodiment, the handheld device 30 includes an enclosure or body that protects the interior components from physical damage and shields them from electromagnetic interference. The enclosure may be formed from any suitable material such as plastic, metal or a composite material and may allow certain frequencies of electromagnetic radiation to pass through to wireless communication circuitry within the handheld device 30 to facilitate wireless communication.

In the depicted embodiment, the enclosure includes user input structures 14 through which a user may interface with the device. Each user input structure 14 may be configured to help control a device function when actuated. For example, in a cellular telephone implementation, one or more of the input structures 14 may be configured to invoke a “home” screen or menu to be displayed, to toggle between a sleep and a wake mode, to silence a ringer for a cell phone application, to increase or decrease a volume output, and so forth.

In the depicted embodiment, the handheld device 30 includes a display 10 in the form of an LCD 32. The LCD 32 may be used to display a graphical user interface (GUI) 34 that allows a user to interact with the handheld device 30. The GUI 34 may include various layers, windows, screens, templates, or other graphical elements that may be displayed in all, or a portion, of the LCD 32. Generally, the GUI 34 may include graphical elements that represent applications and functions of the electronic device. The graphical elements may include icons 36 and other images representing buttons, sliders, menu bars, and the like. The icons 36 may correspond to various applications of the electronic device that may open upon selection of a respective icon 36. Furthermore, selection of an icon 36 may lead to a hierarchical navigation process, such that selection of an icon 36 leads to a screen that includes one or more additional icons or other GUI elements. The icons 36 may be selected via a touch screen included in the display 10, or may be selected by a user input structure 14, such as a wheel or button.

The handheld electronic device 30 also may include various input and output (I/O) ports 12 that allow connection of the handheld device 30 to external devices. For example, one I/O port 12 may be a port that allows the transmission and reception of data or commands between the handheld electronic device 30 and another electronic device, such as a computer. Such an I/O port 12 may be a proprietary port from Apple Inc. or may be an open standard I/O port.

In addition to handheld devices 30, such as the depicted cellular telephone of FIG. 2, an electronic device 8 may also take the form of a computer or other type of electronic device. Such computers may include computers that are generally portable (such as laptop, notebook, and tablet computers) as well as computers that are generally used in one place (such as conventional desktop computers, workstations and/or servers). In certain embodiments, the electronic device 8 in the form of a computer may be a model of a MacBook®, MacBook® Pro, MacBook Air®, iMac®, Mac® mini, or Mac Pro® available from Apple Inc. By way of example, an electronic device 8 in the form of a laptop computer 50 is illustrated in FIG. 3 in accordance with one embodiment of the present invention. The depicted computer 50 includes a housing 52, a display 10 (such as the depicted LCD 32), input structures 14, and input/output ports 12.

In one embodiment, the input structures 14 (such as a keyboard and/or touchpad) may be used to interact with the computer 50, such as to start, control, or operate a GUI or applications running on the computer 50. For example, a keyboard and/or touchpad may allow a user to navigate a user interface or application interface displayed on the LCD 32.

As depicted, the electronic device 8 in the form of computer 50 may also include various input and output ports 12 to allow connection of additional devices. For example, the computer 50 may include an I/O port 12, such as a USB port or other port, suitable for connecting to another electronic device, a projector, a supplemental display, and so forth. In addition, the computer 50 may include network connectivity, memory, and storage capabilities, as described with respect to FIG. 1. As a result, the computer 50 may store and execute a GUI and other applications.

With the foregoing discussion in mind, it may be appreciated that an electronic device 8 in either the form of a handheld device 30 or a computer 50 may be provided with a display 10 in the form of an LCD 32. Such an LCD 32 may be utilized to display the respective operating system and application interfaces running on the electronic device 8 and/or to display data, images, or other visual outputs associated with an operation of the electronic device 8.

In embodiments in which the electronic device 8 includes an LCD 32, the LCD 32 may typically include an array or matrix of picture elements (i.e., pixels). In operation, the LCD 32 generally operates to modulate the transmittance of light through each pixel by controlling the orientation of liquid crystal disposed at each pixel such that the amount of emitted or reflected light emitted by each pixel is controlled. In general, the orientation of the liquid crystals is controlled by a varying electric field associated with each respective pixel, with the liquid crystals being oriented at any given instant by the properties (strength, shape, and so forth) of the electric field.

Different types of LCDs may employ different techniques in manipulating these electrical fields and/or the liquid crystals. For example, certain LCDs employ transverse electric field modes in which the liquid crystals are oriented by applying an in-plane electrical field to a layer of the liquid crystals. Example of such techniques include in-plane switching (IPS) and fringe field switching (FFS) techniques, which differ in the electrode arrangement employed to generate the respective electrical fields.

While control of the orientation of the liquid crystals in such displays may be sufficient to modulate the amount of light emitted by a pixel, color filters may also be associated with the pixels to allow specific colors of light to be emitted by each pixel. For example, in embodiments where the LCD 32 is a color display, each pixel of a group of pixels may correspond to a different primary color. For example, in one embodiment, a group of pixels may include a red pixel, a green pixel, and a blue pixel, each associated with an appropriately colored filter. The intensity of light allowed to pass through each pixel (by modulation of the corresponding liquid crystals), and its combination with the light emitted from other adjacent pixels, determines what color(s) are perceived by a user viewing the display. As the viewable colors are formed from individual color components (e.g., red, green, and blue) provided by the colored pixels, the colored pixels may also be referred to as unit pixels.

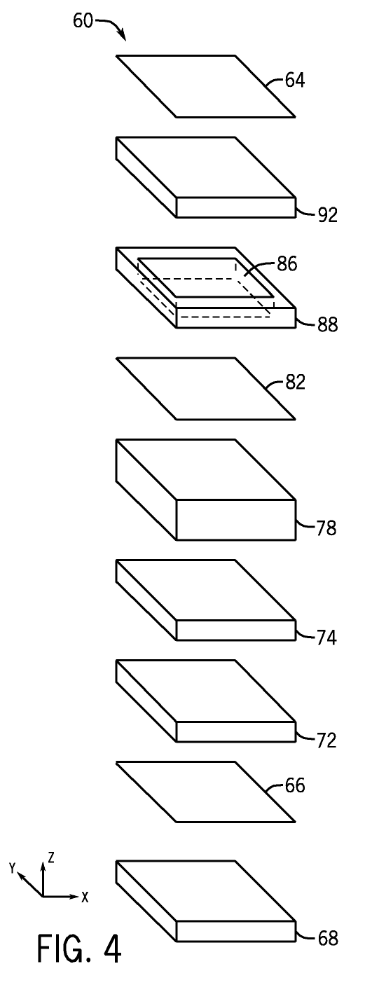

With the foregoing in mind, and turning once again to the figures, FIG. 4 depicts an exploded view of different layers of a pixel of an LCD 32. The pixel 60 includes an upper polarizing layer 64 and a lower polarizing layer 66 that polarize light emitted by a backlight assembly 68 or light-reflective surface. A lower substrate 72 is disposed above the polarizing layer 66 and is generally formed from a light-transparent material, such as glass, quartz, and/or plastic.

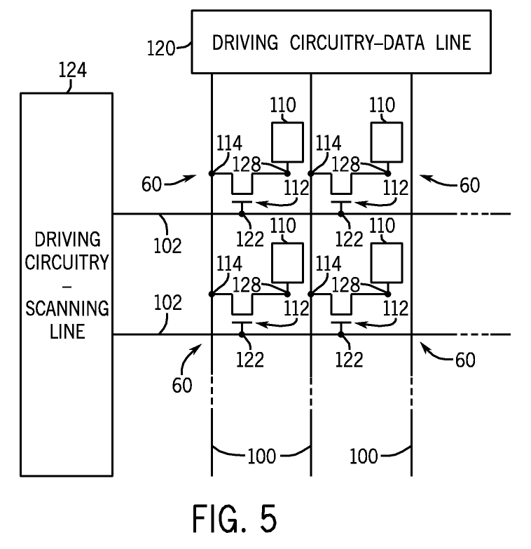

A thin film transistor (TFT) layer 74 is depicted as being disposed above the lower substrate 72. For simplicity of illustration, the TFT layer 74 is depicted as a generalized structure in FIG. 4. In practice, the TFT layer may itself comprise various conductive, non-conductive, and semiconductive layers and structures which generally form the electrical devices and pathways which drive operation of the pixel 60. For example, in an embodiment in which the pixel 60 is part of an FFS LCD panel, the TFT layer 74 may include the respective data lines, scanning lines, pixel electrodes, and common electrodes (as well as other conductive traces and structures) of the pixel 60. Such conductive structures may, in light-transmissive portions of the pixel, be formed using transparent conductive materials, such as indium tin oxide (ITO). In addition, the TFT layer 74 may include insulating layers (such as a gate insulating film) formed from suitable transparent materials (such as silicon oxide) and semiconductive layers formed from suitable semiconductor materials (such as amorphous silicon). In general, the respective conductive structures and traces, insulating structures, and semiconductor structures may be suitably disposed to form the respective pixel and common electrodes, a TFT, and the respective data and scanning lines used to operate the pixel 60, as described in further detail with regard to FIG. 5. The TFT layer 74 may also include an alignment layer (formed from polyimide or other suitable materials) at the interface with the liquid crystal layer 78.

The liquid crystal layer 78 includes liquid crystal particles or molecules suspended in a fluid or gel matrix. The liquid crystal particles may be oriented or aligned with respect to an electrical field generated by the TFT layer 74. The orientation of the liquid crystal particles in the liquid crystal layer 78 determines the amount of light transmission through the pixel 60. Thus, by modulation of the electrical field applied to the liquid crystal layer 78, the amount of light transmitted though the pixel 60 may be correspondingly modulated.

Disposed on the other side of the liquid crystal layer 78 from the TFT layer 74 may be one or more alignment and/or overcoating layers 82 interfacing between the liquid crystal layer 78 and an overlying color filter 86. The color filter 86, in certain embodiments, may be a red, green, or blue filter, such that each pixel 60 corresponds to a primary color when light is transmitted from the backlight assembly 68 through the liquid crystal layer 78 and the color filter 86.

The color filter 86 may be surrounded by a light-opaque mask or matrix, e.g., a black mask 88 which circumscribes the light-transmissive portion of the pixel 60. For example, in certain embodiments, the black mask 88 may be sized and shaped to define a light-transmissive aperture over the liquid crystal layer 78 and around the color filter 86 and to cover or mask portions of the pixel 60 that do not transmit light, such as the scanning line and data line driving circuitry, the TFT, and the periphery of the pixel 60. In the depicted embodiment, an upper substrate 92 may be disposed between the black mask 88 and color filter 86 and the polarizing layer 64. In such an embodiment, the upper substrate 92 may be formed from light-transmissive glass, quartz, and/or plastic.

Referring now to FIG. 5, an example of a circuit view of pixel driving circuitry found in an LCD 32 is provided. For example, such circuitry as depicted in FIG. 5 may be embodied in the TFT layer 74 described with respect to FIG. 4. As depicted, the pixels 60 may be disposed in a matrix that forms an image display region of an LCD 32. In such a matrix, each pixel 60 may be defined by the intersection of data lines 100 and scanning or gate lines 102.

Each pixel 60 includes a pixel electrode 110 and thin film transistor (TFT) 112 for switching the pixel electrode 110. In the depicted embodiment, the source 114 of each TFT 112 is electrically connected to a data line 100, extending from respective data line driving circuitry 120. Similarly, in the depicted embodiment, the gate 122 of each TFT 112 is electrically connected to a scanning or gate line 102, extending from respective scanning line driving circuitry 124. In the depicted embodiment, the pixel electrode 110 is electrically connected to a drain 128 of the respective TFT 112.

In one embodiment, the data line driving circuitry 120 sends image signals to the pixels via the respective data lines 100. Such image signals may be applied by line-sequence, i.e., the data lines 100 may be sequentially activated during operation. The scanning lines 102 may apply scanning signals from the scanning line driving circuitry 124 to the gate 122 of each TFT 112 to which the respective scanning lines 102 connect. Such scanning signals may be applied by line-sequence with a predetermined timing and/or in a pulsed manner.

Each TFT 112 serves as a switching element which may be activated and deactivated (i.e., turned on and off) for a predetermined period based on the respective presence or absence of a scanning signal at the gate 122 of the TFT 112. When activated, a TFT 112 may store the image signals received via a respective data line 100 as a charge in the pixel electrode 110 with a predetermined timing.

The image signals stored at the pixel electrode 110 may be used to generate an electrical field between the respective pixel electrode 110 and a common electrode. Such an electrical field may align liquid crystals within the liquid crystal layer 78 (FIG. 4) to modulate light transmission through the liquid crystal layer 78. In some embodiments, a storage capacitor may also be provided in parallel to the liquid crystal capacitor formed between the pixel electrode 110 and the common electrode to prevent leakage of the stored image signal at the pixel electrode 110. For example, such a storage capacitor may be provided between the drain 128 of the respective TFT 112 and a separate capacitor line.

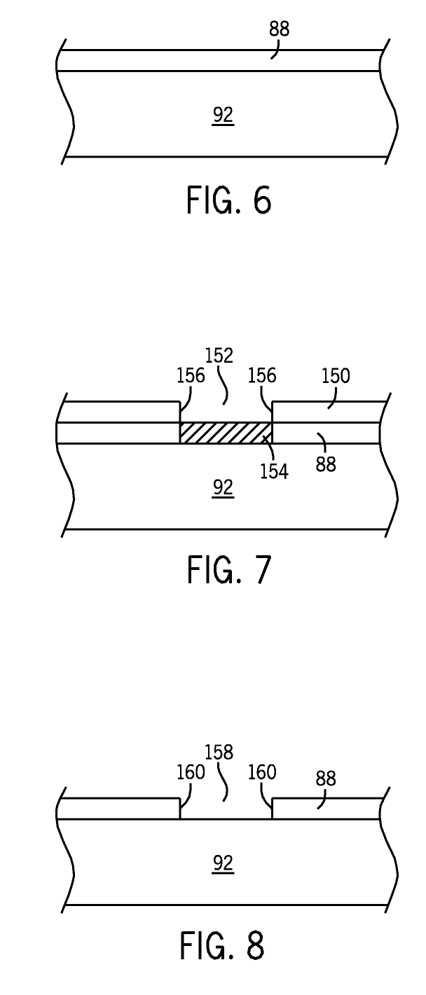

A sectional side view of some of layers within the pixel 60 is depicted in FIG. 6. In addition, FIG. 6, FIG. 7, and FIG. 8 are used to illustrate examples of the layers during steps or stages of a process to form the black mask 88 during manufacture of an LCD display 32. In the embodiment depicted in FIG. 6, the upper substrate 92 and the black mask 88 are shown. Accordingly, in the first step illustrated by FIG. 6, the black mask 88 is formed on a surface of the upper substrate 92. As may be appreciated, the black mask 88 may be formed on a surface of the upper substrate 92 which may be coupled to the lower substrate 72 and other layers within the LCD assembly to encompass the liquid crystal 78. The black mask 88 may be composed of a suitable material designed to absorb light to mask certain portions near a frame or outer portion of the pixel 60. For example, the black mask 88 may include a polymer and/or composite material, which may prevent light from bleeding between adjacent pixels and provide an area for the scanning lines 102 and/or data lines 100 to be routed between pixels. As discussed with respect to FIG. 4, an aperture created in the black mask 88 may be filled with a color filter, wherein the color filter is configured to transmit a red, green, or blue light. In one embodiment where the LCD display is a monochrome display, the pixels in the display may not include color filters. As may be appreciated, the sectional side views shown in FIGS. 6-8 illustrate the process of creating an aperture in the black mask 88. Further, such a process may be performed on the entire set of pixels in the LCD display at one time, to create a plurality of black mask apertures for each of the pixels.

FIG. 7 is a sectional view illustrating an example of layers of a pixel where a patterning layer, such as a photoresist layer 150, is placed on top of the black mask 88. The photoresist layer 150 may be patterned to include an aperture 152 that exposes a portion of the black mask 88. The aperture 152 in the resist layer 150 may determine the portion of black mask 88 that may be removed. For example, the aperture 152 in the photoresist layer 150 may expose a substantially rectangular portion 154 of the black mask 88. The exposed portion 154 of the black mask 88 may be removed by an etching or other suitable process, thereby exposing a substantially rectangular portion of the upper substrate 92. In one embodiment, edges 156 of the aperture 152 may generally define the perimeter or geometry of the portion 154 to be removed. For instance, an etching process, such as dry or wet etching, may be used to remove the portion 154 of the black mask 88, thereby creating an aperture 158, as shown in FIG. 8 following removal of the photoresist layer 150. The etching process forms aperture edges 160 by performing the etching process on the exposed area 154 defined by resist edges 156. Thus, the shape of the area or portion 154 exposed by resist aperture 152 and edges 156 determine the shape of the aperture 158 in black mask 88 and the amount of light transmitted from the pixel 60.

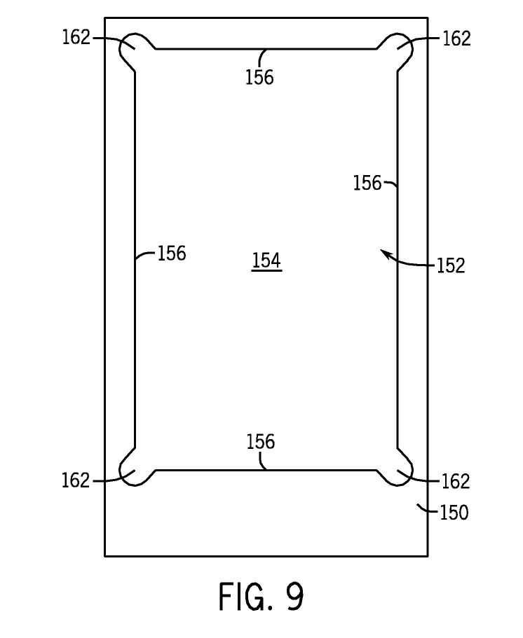

FIG. 9 is a top view of an example of the photoresist layer 150 placed on top of the black mask 88, prior to an etching process. As depicted, the exposed portion 154 of the black mask 88 is defined by the substantially rectangular shaped aperture 152 in the photoresist layer 150. Additionally, the aperture edges 156 may be oriented at substantially right angles to one another to form the rectangular geometry for the etching process. As depicted, the edges 156 do not intersect at right angles. In one embodiment, the substantially rectangular aperture 152 may include overshaped corners, at the intersection of adjacent edges 156. As used herein to describe both the patterning layer (e.g., photoresist layer 150) and the black mask 88, “corners” refer to the region where two converging edges (edges 156 of the photoresist layer 150 or edges 160 of the black mask 88) intersect. Thus, the term “corner” does not connote a particular shape of the intersection region and should not be interpreted to connote a right angle.

For example, in accordance with one embodiment, elliptical shaped openings 162 may be located at the intersection of adjacent edges 156 (i.e., corners). The elliptical corner openings 162 enable a larger portion of the black mask 88 to be removed from the corner sections than would be removed if the adjacent sides intersected at right angles. For instance, the elliptical corner openings 162 located in each of the four corners of the aperture 152 may enable a larger portion 154 of the black mask to be exposed in the corner areas, thereby enabling substantially right angled corners of a rectangle to be formed by etching the black mask 88.

In another embodiment where adjacent sides 156 intersect at substantially right angles in the corners, less of the black mask 88 is exposed. In such a case, less of the black mask 88 from these right angle corners may be removed by an etching process, causing the aperture corners to be substantially chamfered. As depicted, adjacent sides 156 are oriented at substantially right angles to one another, but the corners are overshaped, i.e. the edges 156 do not intersect at right angles. The aperture 152 corners are overshaped in the geometry of elliptical openings 162. The overshaped elliptical openings 162 enable a larger portion of the black mask 88 to be exposed for an etching process, thereby creating a larger aperture 158 to increase light transmission in the pixel 60. In other embodiments, the overshaped corners may have a different geometry, such as circular shape or the intersection of two curved or convex sides at less than a right angle.

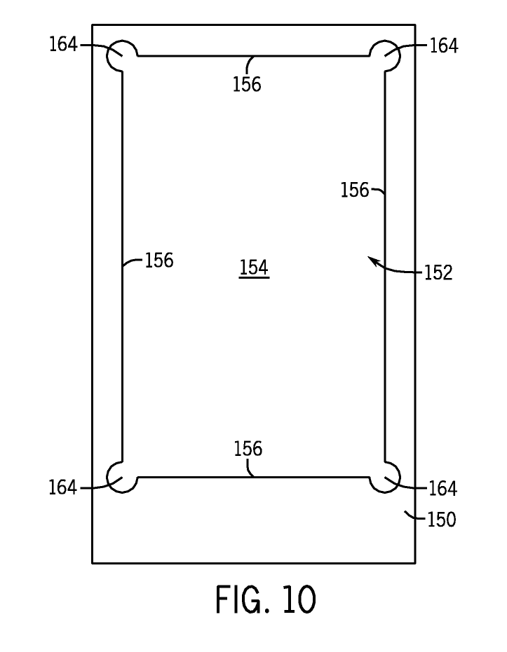

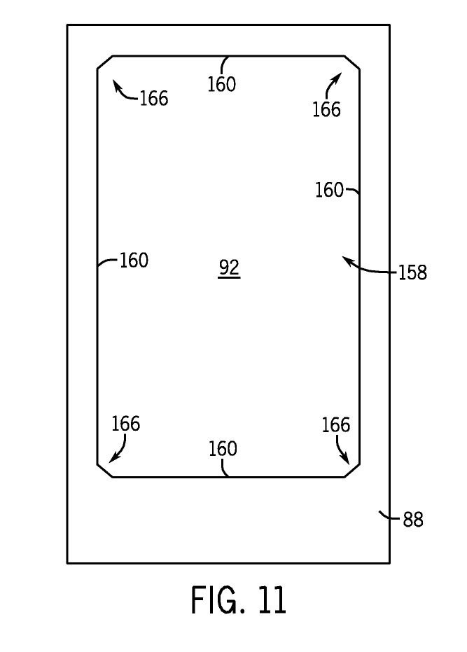

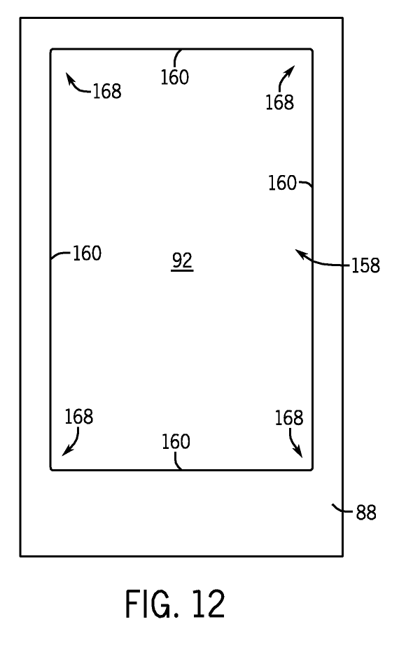

FIG. 10 is a top view of an example of components of the pixel 60, including the photoresist layer 150 placed on top of the black mask 88 to expose a portion 154 that may be removed by an etching process. As discussed above with respect to FIG. 9, the exposed portion 154 may be removed by an etching process and is generally defined by the aperture 152 in the photoresist layer 150. In the depicted embodiment, the aperture 152 may be described as substantially rectangular with overshaped corners. For example, circular corner openings 164 are overshaped corners utilized during the etching process, thereby enabling a larger portion of the black mask 88 to be removed. In one embodiment, the circular shaped openings 164 are formed at the intersection of adjacent sides 156. Accordingly, the overshaped circular shaped corners 164 provide an increased exposed portion 154 than may be provided by embodiments where adjacent sides intersect at substantially right angles. Accordingly, the illustrated substantially rectangular opening 152 enables a larger portion 154 of the black mask 88 to be removed, enabling a greater amount of light to be transmitted from the liquid crystal of the pixel 60. Specifically, the depicted substantially rectangular aperture 152 and overshaped circular corners 164 enable a substantially rectangular portion 154 to be removed, wherein the black mask aperture 158 created by the etching process has corners formed by substantially right angles. Examples of the apertures created by an etching process are illustrated in FIGS. 11 and 12. In FIG. 11 an aperture 158 includes substantially chamfered corners 166. In the depicted embodiment, the aperture 158 may be formed by an etching process that utilizes a photoresist pattern that includes corners that intersect at right angles. Thus, the chamfered corners 166 are produced.

In FIG. 12, a substantially rectangular aperture 158 in the black mask 88 is shown with the resist layer 150 removed after the etching process is complete. Specifically, the etching process to form the depicted aperture 158 utilizes a photoresist pattern with overshaped corners to remove a greater amount of black mask, thereby increasing the light transmitted through the aperture as compared to the embodiment shown in FIG. 11. Accordingly, the etching process exposes a substantially rectangular portion with substantially right angled corners 168 of the upper substrate 92 to enable transmission of light from the pixel 60.

As may be appreciated, the patterning of the overshaped corners in the photoresist layer 150 and the substantially rectangular aperture 158 created by the etching process provides substantially right angled corners 168 in the aperture 158. In one embodiment, the corners 168 may be described as rounded corners. In addition, adjacent sides 160 of the substantially rectangular opening 158 may be oriented at substantially right angles. As previously discussed with respect to FIG. 11, certain embodiments of the photoresist layer 150 and aperture 152 may result in a chamfered corner in the mask aperture 158, thereby causing a greater portion of light to be blocked by the black mask 88. Accordingly, in the embodiment depicted by FIG. 12, the substantially rectangular aperture 158 and corners 168 created by the photoresist layer 150 may be described as not chamfered, or as not substantially chamfered, wherein the corners are squared or at right angles to enable an increased amount of light transmission as compared to a mask aperture with substantially chamfered corners 166.

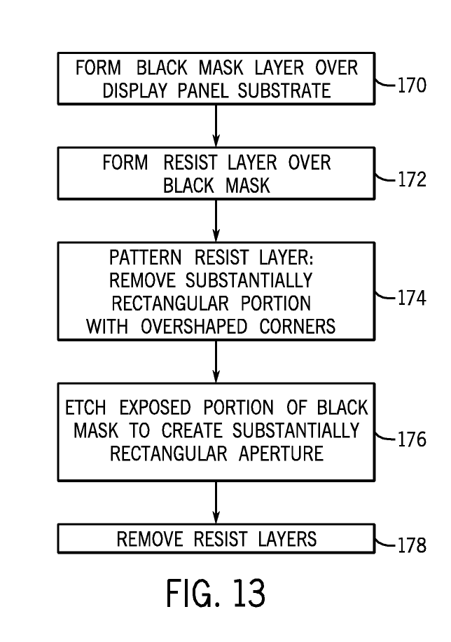

FIG. 13 is an example of a process used to create the black mask 88 within the pixel 60. In step 170, the black mask may be formed on a surface of the display panel substrate. For instance, a material, such as polymer, may be used as a black mask and may be formed as a layer on a surface of upper substrate 92. In step 172, a patterning layer, such as a photoresist layer, is formed over the black mask. The patterning layer is an intermediate layer which may be used to create the black mask and is generally removed after the black mask has been formed.

The patterning layer is patterned in step 174, where a substantially rectangular portion of the patterning layer may be removed to expose the portion of black mask to be removed by etching. The patterning process includes removing overshaped corners of the rectangular portion. The overshaped corners may include elliptical shaped corners, circular shaped corners, angular corners with more than two sides, curved corners or a combination thereof. For instance, in one embodiment, the overshaped corners may include curved portions which curve outward from the center of the aperture, thereby causing the sides of the substantially rectangular shaped aperture to intersect at an angle of between about 70 and 90 degrees. In another embodiment, the corners may be squared notches, with three sides of the square protruding outward from the aperture to produce an overshaped opening. The overshaped corners of the patterning layer increase the area of the exposed black mask portion, formed using the patterning layer, to enable a greater portion of light to be transmitted through the pixel 60 than may be transmitted if the corners of the patterning layer are not overshaped. For example, in an embodiment where the corners of the patterning layer are not overshaped, the aperture created in the black mask by using the patterning layer may include chamfered corners which reduce the amount of light transmitted from the pixel.

In the embodiments discussed above, the exposed portion of the black mask may be etched, as shown in step 176, or otherwise removed. The etching of the exposed portion may create a substantially rectangular aperture in the black mask that includes corners that are not chamfered. In one embodiment, the corners may be described as substantially rounded. After the etching process in step 178, the patterning layer is removed and the remainder of layers within the pixel 60 may be assembled to produce the LCD display. As may be appreciated, a color filter may be placed within the aperture created by the black mask formation process, wherein the color filter enables the pixel to transmit a primary color such as red, green, or blue.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

What is claimed is:

1. A display panel, comprising:
a first substrate including an electrode configured to generate an electric field;
a second substrate including a black mask, the black mask including an aperture configured to enable light to be transmitted through the aperture, wherein the aperture is substantially rectangular and includes corners that form substantially right angles; and
liquid crystal disposed between the first and second substrates and configured to facilitate passage of light through the display panel in response to the electric field.

2. The display panel of claim 1, wherein the corners are not substantially chamfered.

3. The display panel of claim 2, wherein the corners comprise rounded corners.

4. The display panel of claim 1, wherein the display panel includes a fringe field switching display panel.

5. The display panel of claim 1, comprising a color filter.

6. The display panel of claim 1, wherein the first substrate includes an additional electrode and an insulating layer.

7. A method of manufacturing a display panel, the method comprising:
forming a black mask over a fringe-field switching display panel substrate;
forming a patterning layer over the black mask; and
patterning the patterning layer to expose a portion of the black mask, wherein patterning the patterning layer includes removing a substantially rectangular portion of the patterning layer, the substantially rectangular portion including an overshaped geometry at intersections of sides of the substantially rectangular portion.

8. The method of claim 7, wherein the overshaped geometry includes substantially elliptical portions.

9. The method of claim 7, wherein the overshaped geometry includes circular portions.

10. The method of claim 7, comprising etching the exposed portion of the black mask.

11. The method of claim 7, wherein the sides are convex, such that the sides diverge from one another at the corners, and wherein the overshaped geometry includes an angle of intersection of the sides of less than 90 degrees.

12. The method of claim 7, wherein forming a black mask comprises forming a polymer material.

13. The method of claim 7, wherein removing a substantially rectangular portion of the patterning layer enables substantially right angled corners to be formed in the black mask by an etching process.

14. The method of claim 7, wherein forming a patterning layer comprises forming a photoresist layer over the black mask.

15. A display panel pixel, comprising:
a black mask, including:
a rectangular aperture; and
corners of the rectangular aperture configured to enable an increased transmission of light from the pixel.

16. The display panel pixel of claim 15, wherein the corners are substantially rounded.

17. The display panel pixel of claim 15, comprising a liquid crystal layer, a color filter and a substrate that includes an electrode.

18. An electronic device, comprising:
an integrated circuit; and
a display panel, including:
a substrate; and
a black mask coupled to the substrate, wherein the black mask is configured to absorb light incident on a surface of the black mask, and wherein an aperture in the black mask is configured to transmit light and comprises four legs which intersect at substantially right angles.

19. The electronic device of claim 18, wherein the aperture in the black mask is formed by etching the black mask utilizing a patterning layer that includes overshaped corners.

20. The device of claim 18, comprising a memory device and a processor.

21. The device of claim 18, wherein the aperture comprises a substantially rectangular shape with corners that are not chamfered.

22. The device of claim 18, comprising a handheld device.

23. The device of claim 18, comprising a portable computer.
